(19) United States
(12) Patent Application Publication
(10) Pub. No.: US 2024/0362477 A1
(43) Pub. Date: Oct. 31, 2024

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Masaharu YAMAMOTO, Yokohama Kanagawa (JP); Shigeru MAYA, Edogawa Tokyo (JP)

(73) Assignee: KABUSHIKI KAISHA TOSHIBA, Tokyo (JP)

(21) Appl. No.: 18/584,064

(22) Filed: Feb. 22, 2024

(30) Foreign Application Priority Data
Apr. 26, 2023 (JP) 2023-072296

(51) Int. Cl. G06N 3/08

(52) U.S. Cl. CPC G06N 3/08

(57) ABSTRACT

According to one embodiment, an information processing device includes one or more processors. The one or more processors are configured to generate a generation function for generating a local waveform used for a continuous wavelet transform, at least part of the generation function being expressed by a machine learning model; and learn the generation function by using learning data including a first input signal.

### CROSS-REFERENCE TO RELATED APPLICATIONS

This application is based upon and claims the benefit of priority from Japanese Patent Application No. 2023-072296, filed on Apr. 26, 2023; the entire contents of which are incorporated herein by reference.

### FIELD

Embodiments described herein generally relate to an information processing device, an information processing method, and a computer program product.

### BACKGROUND

Feature values extracted from time-series signals are utilized for failure prediction and maintenance, such as anomaly detection and useful life estimation of devices. For devices that operate cyclically, such as bearings, feature values related to time-series frequency components and time information are used.

There is a proposed technology that applies wavelet transform (wavelet analysis) to acquire feature values of time-series signals. The wavelet transform includes the discrete wavelet transform (discrete transform) that enables fast analysis and the continuous wavelet transform (continuous transform) that enables time-frequency analysis with high resolution by providing redundancy to the analysis results. The wavelet transforms give excellent feature values for performing time-series state estimation.

### BRIEF DESCRIPTION OF THE DRAWINGS

FIG. 1 is a block diagram of an information processing device according to a first embodiment;

FIG. 2 is a diagram illustrating an example of signals stored in a storage unit;

FIG. 3 is a diagram illustrating a configuration example of a generation function;

FIG. 4 is a flowchart of learning processing;

FIG. 5 is a flowchart of wavelet representation calculation processing;

FIG. 6 is a flowchart of estimation processing;

FIG. 7 is a diagram illustrating an example of a display screen of an estimation result according to the first embodiment;

FIG. 8 is a diagram illustrating an example of a display screen of an estimation result according to the first embodiment;

FIG. 9 is a block diagram of an information processing device according to a second embodiment;

FIG. 10 is a diagram illustrating an example of a display screen of an estimation result according to the second embodiment; and

FIG. 11 is a hardware configuration diagram of the information processing device according to the first or second embodiment.

### DETAILED DESCRIPTION

In general, according to one embodiment, an information processing device includes one or more processors. The one or more processors are configured to: generate a generation function for generating a local waveform used for a continuous wavelet transform, at least part of the generation function being expressed by a machine learning model; and learn the generation function by using learning data including a first input signal.

Exemplary embodiments of an information processing device will be explained below in detail with reference to the accompanying drawings. The present invention is not limited to the following embodiments.

As a method for performing frequency analysis, there is fast Fourier transform (FFT). FFT is not suitable for analysis where a sudden phenomenon occurs, since it loses all time information included in signals. As a method to overcome the disadvantages of FFT, which is to lose time information, there is short-term Fourier transform (STFT). It is possible with STFT to capture time-frequency information by performing Fourier transform on the signals within a window function while shifting a compact window function at each time. However, due to the uncertainty principle, there is a trade-off relationship between time accuracy and frequency accuracy. Therefore, it is not possible to perform highly accurate analysis covering a plurality of frequency domains using STFT that uses a fixed window width.

Wavelet analysis is a method that enables time-frequency analysis by examining the time correlation of a single local waveform called an analyzing wavelet while changing scales. Unlike STFT, the wavelet analysis can be used for various frequencies by decreasing the scale to zoom in for the high-frequency component and increasing the scale for the low-frequency component.

Local waveforms used in the wavelet analysis may give different analysis results depending on the function form (form of the function used to generate the local waveforms). In regards to discrete wavelet transform, a technology is proposed for enabling analysis with higher accuracy by using a neural network that is trained to match the local waveform to be generated with the data.

On the other hand, the discrete wavelet transform has low time-frequency resolution and cannot detect slight frequency differences. Therefore, even with the configuration that uses neural networks, state estimation requiring detailed frequency information is still difficult.

While an existing function such as Mexican hat is used for the continuous wavelet transform, it is difficult to implement functions specified for tasks with neural networks due to the complexity of the wavelet configuration conditions.

The following embodiments implement the continuous wavelet transform using wavelets that can be used more universally, and enable execution of signal analysis using the wavelet transform with higher accuracy.

### First Embodiment

An information processing device according to a first embodiment expresses a generation function for generating a local waveform (analyzing wavelet) used in the continuous wavelet transform by a machine learning model, and learns the generation function by unsupervised learning.

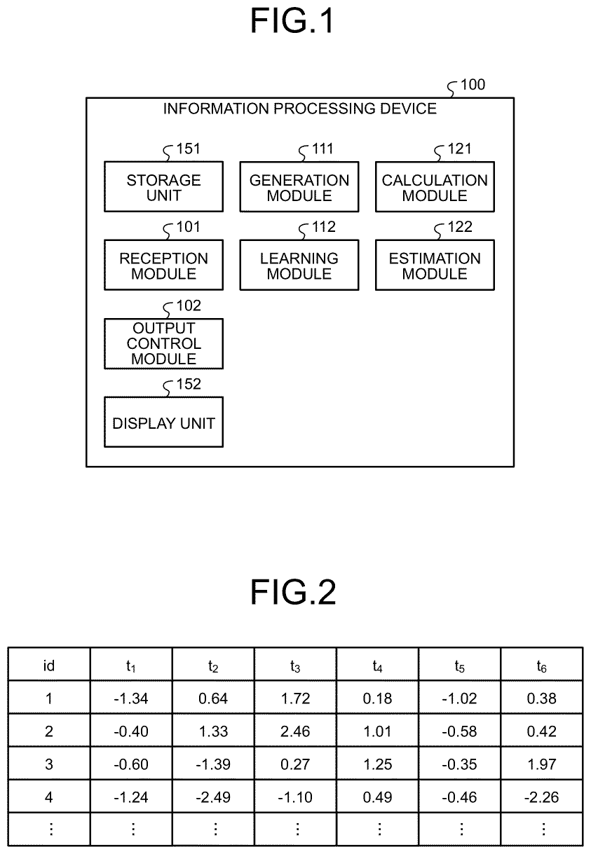

FIG. 1 is a block diagram illustrating an example of the configuration of an information processing device 100 according to the first embodiment. As illustrated in FIG. 1, the information processing device 100 includes a storage unit 151, a display unit 152, a reception module 101, an output control module 102, a generation module 111, a learning module 112, a calculation module 121, and an estimation module 122.

The storage unit 151 stores various kinds of information used in the information processing device. For example, the storage unit 151 stores signals used for learning and signals to be the target of analysis.

FIG. 2 is a diagram illustrating an example of signals stored in the storage unit 151. In the example in FIG. 2, the storage unit 151 stores id that is the identification information that identifies a signal, and the value of the signal at each time (t₁ to t₀, and the like). Note that FIG. 2 illustrates an example where signal values at six kinds of times as one unit. For example, among time-series signals output constantly, the storage unit 151 may store, as a unit, signals that are sampled periodically or signals sampled at designated times. This suppresses the increase of the memory area for storing the signals. The signals in FIG. 2 are examples only, and signals are not limited thereto. For example, signal values at other number of times than six may be stored as a single unit.

The signals may be any types of signals and, for example, the following signals can be used. As in the followings, signals are not limited to time-series signals (time-series data), but may be any types (formats) of data as long as the wavelet transform can be applied.
Vibration data, sound data, and time-series data representing operational steps or the like.
Image data (still images, moving images).

The present embodiment can be applied to estimation of a state of the following target, for example.
A device such as a bearing is taken as a target, and estimate the state (anomaly and the like) of the device using time-series signals detected from the device by a sensor (detection device).

As for the signals, preprocessing may be applied. Preprocessing is, for example, independent component analysis that decomposes signals into independent components, and transformation that changes at least one of the mean and variance of the signals. For example, the preprocessing may be processing for shifting the signal values such that the mean thereof becomes 0.

The storage unit 151 may be configured with any commonly used storage media such as a flash memory, a memory card, a Random Access Memory (RAM), a Hard Disk Drive (HDD), and an optical disk.

The display unit 152 is a display device for displaying various kinds of information used in the information processing device, and it is achieved, for example, by a liquid crystal display or the like.

The reception module 101 receives input of various kinds of information used in the information processing device. For example, the reception module 101 receives input of signals. Signals may be transmitted from a device to be the target of state estimation, for example. Signals may be input sequentially (in real time) or may be input every certain period of time. A plurality of signals may be input collectively when designated by a user or the like.

The output control module 102 controls the output of various kinds of information used in the information processing device. For example, the output control module 102 controls the processing of displaying the estimation result acquired by the estimation module 122 on the display unit 152.

The generation module 111 generates a generation function for generating a local waveform used in the continuous wavelet transform. The local waveform is, for example, an analyzing wavelet (also called mother wavelet). The generation function is a function in the Fourier domain (frequency domain) that is at least partially expressed by a machine learning model. A machine learning model is, for example, a neural network model defined in the Fourier domain (hereinafter, may simply be referred to as a neural network). In a neural network, parameters such as weights and biases are updated by learning.

The machine learning model is not limited to a neural network, but can be any model that is built by adjusting (updating) parameters. For example, the machine learning model may be a model in which a plurality of wavelets are integrated based on parameters.

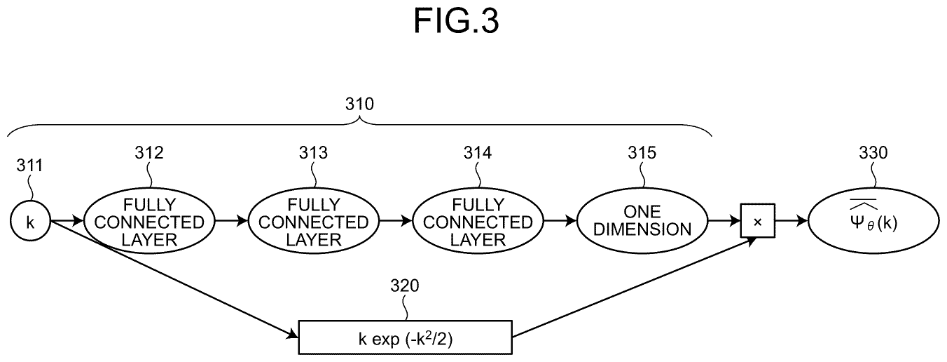

FIG. 3 is a diagram illustrating a configuration example of a generation function. As illustrated in FIG. 3, the generation function includes a neural network 310 and a function 320. The neural network 310 includes an input layer 311, fully connected layers 312 to 314 as the intermediate layers, and an output layer 315. The input layer 311 receives input of a frequency component k, which is represented in one dimension, for example. The output layer 315 outputs one-dimensional output values, for example. Note that FIG. 3 is an example of a case where the generation function is a real function. The generation function may also be a complex function. When the generation function is a complex function, the neural network 310 may receive input of the frequency component k expressed by a one-dimensional real number and output a two-dimensional output value containing a real part and an imaginary part.

A function that is a multiplication of an output value of the output layer of the neural network 310 and the function 320 is generated as a generation function 330. The generation function 330 satisfies the allowable condition that is to be met as an analyzing wavelet. The allowable condition is that, for example, for a function ψ, a function ψ\hat{ } (function with the hat symbol applied above ψ) expressed in the Fourier domain of the function ψ satisfies the following equation (1).

$${\int }_{- ∞}^{∞} dk \frac{{\vert i \hat{p} ( k ) \vert}^{2}}{k} < ∞ \qquad ( 1 )$$

An example of the generation function including a neural network that satisfies the allowable condition may be a generation function expressed by the following equation (2).

$$\hat{ψ} ( k ) = {ke}^{- \frac{{k}^{2}}{2}} g ( k ) \qquad ( 2 )$$

Note that g(k) represents a neural network that takes a one-dimensional frequency component k as input and outputs a one-dimensional output value. A function kexp (−k²/2) multiplied by g(k) corresponds to the function 320 in FIG. 2, for example. By multiplying the function 320, the generation function comes to be 0 at the origin and to converge to 0 at a sufficient rate in the distance. In other words, the generation function outputs 0 when the input k is 0, and the output converges to 0 at a rate equal to or more than a threshold defined in advance as the input k goes toward infinity. The function 320 can also be interpreted as a decay term that decays the output of the generation function as the input goes toward infinity.

As the neural network g(k), it is possible to use a multilayer-perceptron including an affine transformation and an activation function, a neural network including a mechanism using skip connection, and the like.

When the activation function is a linear unit or Rectified Linear Unit (ReLU), a generation function expressed by the following equation (3) may be used.

$$\hat{ψ} ( k ) = \frac{k}{{( 1 + \vert k \vert )}^{2 + α}} g ( k ) \qquad ( 3 )$$

When the activation function is a logistic sigmoid function or a hyperbolic tangent function (tanh function), a generation function expressed by the following equation (4) may be used.

$$\hat{ψ} ( k ) = \frac{k}{{( 1 + \vert k \vert )}^{1 + α}} g ( k ) \qquad ( 4 )$$

Note that α in the equations (3) and (4) is a value satisfying α>0. The equations (3) and (4) can be interpreted as examples where the decay term is weakened from exponential decay to polynomial decay.

The reason for multiplying the function including k to generate the generation function as in the equations (2) through (4) is to introduce a term that becomes 0 at the origin. As a method for setting it to be 0 at the origin, it is possible to apply a method that eliminates all biases from parameters of the neural network (for example, setting all biases to 0) and uses ReLU or tanh function for the activation function.

To positively limit the support of the generation function on the Fourier domain, the generation function expressed by the following equation (5) may be used. The generation function of the equation (5) is a function that outputs 0 when the input is negative.

$$\hat{ψ} ( k ) = ReLU ( k ) {e}^{- \frac{{k}^{2}}{2}} g ( k ) \qquad ( 5 )$$

Since any of a plurality of types of generation functions as in the equations (2) through (5) can be applied, it is possible to construct wavelets that are more specialized (suitable) for the tasks (targets of estimation).

The learning module 112 learns a generation function generated by the generation module 111. For example, the learning module 112 learns a generation function using learning data that includes an input signal (first input signal) to be the target of analysis.

The learning module 112 first finds the frequency component of an input signal f(x). A calculation method of frequency components may be any conventionally used method. For example, the fast Fourier transform, the Blackman-Turkey method, the maximum entropy method, and the like can be applied. When extracting frequency components by the fast Fourier transform, the learning module 112 may have a window function used in spectral analysis, such as a Hanning window, Hamming window, or Gaussian window, applied to the signals in advance so that no extra spectrum is included.

The learning module 112 calculates a continuous wavelet representation T^{wav}f using the frequency component k and the generation function.

The learning module 112 calculates the product (multiplication) of the frequency component k and the generation function on the Fourier domain as expressed in the following equation (6), and calculates an inverse Fourier transformed signal (first output signal) of the calculated product as the continuous wavelet representation T^{wav}f. For example, F[f(x)](k) corresponds to the frequency component k on the Fourier domain, and the term with a bar applied to ψ\hat{ }(ak) corresponds to the generation function on the Fourier domain. Note that the bar denotes a complex conjugate. F and F⁻¹ denote the Fourier transform and the Fourier inverse transform. Note that a denotes the scale, and b denotes the time.

$${T}^{wav} f ( a , b ) = \sqrt{a} {F}^{- 1} [ F [ f ( x ) ] ( k ) \overline{\hat{ψ}} ( ak ) ] ( b ) \qquad ( 6 )$$

The learning module 112 learns the generation function by optimizing the value of the loss function based on the continuous wavelet representation T^{wav}f. In the present embodiment, the learning module 112 learns the generation function by unsupervised learning.

First, the learning module 112 calculates a feature value from the continuous wavelet representation T^{wav}f. The feature value is calculated as a real number so that it is differentiable when updating the parameters. The feature value is calculated by a functional having the continuous wavelet representation T^{wav}f as input. The functional may be, for example, the following functions.
A function that outputs the entropy of the continuous wavelet representation T^{wav}f as an output value.
A function that outputs, as an output value, a reconstruction error that is the difference between the input signal estimated from the continuous wavelet representation T^{wav}f and the input signal used to calculate the continuous wavelet representation T^{wav}f.

The functional can be determined, for example, in accordance with the target (task) of estimation. This makes it possible to execute analysis of signals using the wavelet transform with higher accuracy.

As described above, the feature value is, for example, the entropy or the reconstruction error. The entropy is calculated, for example, by the following equation (7). Note that p(a, b) in the equation (7) is the normalized absolute value of the continuous wavelet representation |T^{wav}f(a, b)| that is expressed, for example, by the following equation (8).

$$\begin{matrix}H = - \int dloga \int db p ( a , b ) log p ( a , b ) & ( 7 ) \\ p ( a , b ) = \vert {T}^{wav} f ( a , b ) \vert / \int dloga \int db \vert {T}^{wav} f ( a , b ) \vert & ( 8 )\end{matrix}$$

The reconstruction error is calculated, for example, by the following equation (9).

$${L}_{rec} = ‖ f - {f}_{rec} ‖ \qquad ( 9 )$$

Note that ∥ ∥ represents a norm. The norm can be any norm such as L1 norm or L2 norm, for example. Note that f_{rec} represents the reconstructed signal, and it is calculated by the following procedure.
In addition to the wavelet ψ₁ used to acquire the continuous wavelet representation T_{ψ1}^{wav}f(a, b), a function ψ₂ that is defined in the time domain (not Fourier domain) and satisfies the condition expressed by the following equation (10) is prepared. Note that the function ψ₂ may be an existing function or may be constructed with a neural network.

$${C}_{{ψ}_{1} {ψ}_{2}} = \int dk \frac{\vert \hat{{ψ}_{1}} ( k ) \vert \vert \hat{{ψ}_{2}} ( k ) \vert}{\vert k \vert} < ∞ \qquad ( 10 )$$

By using ψ₂, f_{rec} is calculated by the following equation (11). When the value of the continuous wavelet representation T_{ψ1}^{wav}f(a, b) is equal to or less than a threshold, the learning module 112 may perform processing such as changing the value to 0. This makes the learning robust against slight fluctuations in the signals.

$${f}_{rec} ( x ) = {C}_{{ψ}_{1} {ψ}_{2}}^{- 1} \int \frac{da}{{a}^{2}} \int db {T}_{{ψ}_{1}}^{wav} f ( a , b ) {\vert a \vert}^{- \frac{1}{2}} {ψ}_{2} ( \frac{x - b}{a} ) \qquad ( 11 )$$

The learning module 112 acquires a loss function that includes calculated feature values and regularization terms. A regularization term is, for example, the regularization term of the generation function. The regularization terms when the generation function is expressed by the function ψ are calculated, for example, by the following equations (12) through (14). The equations (12), (13), and (14) are the L1 norm of the function ψ, the L2 norm of the function ψ, and the L^{∞} norm of the function ψ, respectively.

$$\begin{matrix}{‖ ψ ‖}_{1} = {\sum }_{n = 1}^{N} \vert ψ ( {x}_{n} ) \vert Δ {x}_{n} & ( 12 ) \\ {‖ ψ ‖}_{2} = \sqrt{{\sum }_{n = 1}^{N} {\vert ψ ( {x}_{n} ) \vert}^{2} Δ {x}_{n}} & ( 13 ) \\ {‖ ψ ‖}_{∞} = max ( ψ ( {x}_{1} ) , … , ψ ( {x}_{N} ) ) & ( 14 )\end{matrix}$$

As for the function ψ, it is assumed that the value at the point (x₁, . . . , x_{N}) is calculated. Also, Δxₙ represents the width between each of the points.

The learning module 112 updates the parameters of the generation function so as to decrease the value of the loss function. While the update method may be any conventionally used method, it is possible to use the error backpropagation method, for example. In the error backpropagation method, the gradient for the parameter of the loss function is acquired and the value of the parameter is updated to the gradient direction. The optimization method for updating parameters may be any conventionally used optimization method, such as stochastic gradient descent, RMSProp, or ADAM.

The learned generation function can thereafter be used for estimation using an input signal (second input signal) newly input to estimate the state of the target. Estimation is mainly executed by the calculation module 121 and the estimation module 122 in the followings. In addition, setting values and the like used in the estimation may be designated by the user or the like.

For example, in addition to the input signals used for estimation, the reception module 101 may receive input of information indicating the range and resolution of the scale where the continuous wavelet transform is performed. Note that the input signal used for estimation may be different from the input signal used during training at least in size (time series length) or sampling rate. For example, when the input signal is a time-series signal over a long period of time, it may be used by being separated into shorter time-series signals.

The calculation module 121 inputs the input signal to the learned generation function and calculates the output signal (second output signal) that is acquired by performing the continuous wavelet transform on the input signal. Like the learning module 112, the calculation module 121 calculates the continuous wavelet representation T^{wav}f using, for example, the equation (6) mentioned above.

When information indicating the range and resolution of the scale is received at the reception module 101, the calculation module 121 determines a scale a according to the information, and calculates the continuous wavelet representation T^{wav}f. The calculation module 121 may determine the range and resolution of the scale based on the magnitude of the frequency component of the signal to be applied. For example, the calculation module 121 may increase the resolution for the higher frequencies.

Like the learning module 112, the calculation module 121 may perform processing such as changing the value to 0 when the value of the continuous wavelet representation T^{wav}f(a, b) is equal to or less than a threshold. This makes the estimation robust against slight fluctuations in the signals.

The estimation module 122 estimates the state of the target using the output signal (continuous wavelet representation) calculated by the calculation module 121. For example, the estimation module 122 calculates the degree of conformance of the input signal, and estimates the state of the target based on the result of a comparison between the degree of conformance and the threshold (threshold for determination of the state).

The degree of conformance, for example, represents the degree of fit between the input signal and the local waveform (analyzing wavelet) generated by the generation function. The degree of conformance is calculated, for example, by Exp(−H), where H is the entropy of the continuous wavelet representation T^{wav}f. The degree of conformance may be normalized to be a value between 0 through 1, both inclusive.

The estimation module 122, for example, estimates that the target is in an anomaly state when the degree of conformance is less than the threshold, and estimates that the target is in a normal state when the degree of conformance is equal to or more than the threshold.

As described above, the output control module 102 displays the estimation result acquired by the estimation module 122 on the display unit 152. Examples of the output of the estimation result from the output control module 102 will be described later.

At least part of each of the above units (the reception module 101, the output control module 102, the generation module 111, the learning module 112, the calculation module 121, and the estimation module 122) may be achieved by a single processing unit. Each of the above units is achieved by a single or a plurality of processors, for example. For example, each of the above units may be achieved by having a processor such as a central processing unit (CPU) and a GPU (Graphics Processing Unit) execute a computer program, that is, by software. Each of the above units may be achieved by a processor such as a dedicated integrated circuit (IC), that is, by hardware. Each of the above units may be achieved by using a combination of software and hardware. When using a plurality of processors, each of the processors may achieve one of the units or may achieve two or more of the units.

Furthermore, the information processing device 100 may be configured with physically a single device or may be configured with physically a plurality of devices. For example, the information processing device 100 may be built on a cloud environment. Furthermore, each of the units in the information processing device 100 may be distributed to a plurality of devices. For example, the information processing device 100 (information processing system) may have a configuration including a device (for example, a learning device) having the functions necessary for learning (for example, the generation module 111 and the learning module 112) and a device (for example, an estimation device) having the functions necessary for estimation (for example, the calculation module 121 and the estimation module 122).

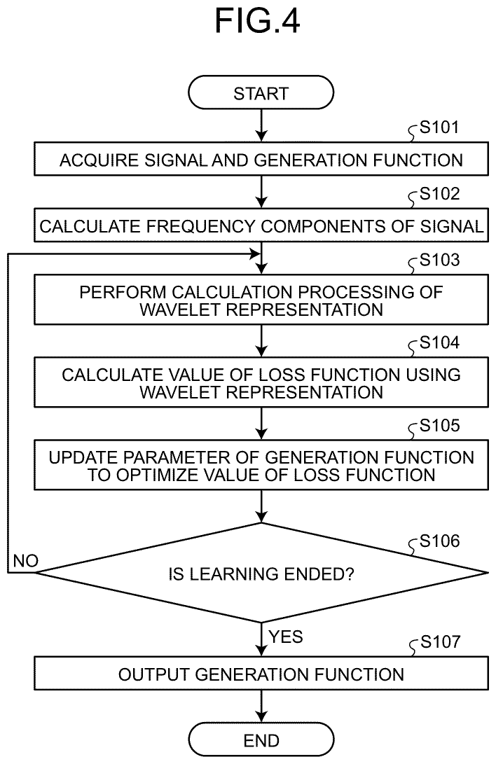

Next, learning processing of the generation function performed by the information processing device 100 according to the first embodiment will be described. FIG. 4 is a flowchart illustrating an example of the learning processing according to the first embodiment.

The learning module 112 acquires the input signal for learning and the generation function (step S101). The input signal is, for example, an input signal received by the reception module 101 and stored in the storage unit 151. The generation function is generated by the generation module 111.

The learning module 112 calculates the frequency components of the input signal (step S102). For example, the learning module 112 calculates the frequency components of the input signal using the fast Fourier transform, the Blackman-Turkey method, the maximum entropy method, and the like.

The learning module 112 calculates the continuous wavelet representation T^{wav}f using the calculated frequency components and the acquired generation function (step S103). The details of the calculation processing of the wavelet representation at step S103 will be described later.

The learning module 112 calculates the value of the loss function using the calculated continuous wavelet representation T^{wav}f(step S104). For example, the learning module 112 calculates the value of the loss function that includes feature values such as the entropy or the reconstruction error calculated using the continuous wavelet representation T^{wav}f, and a regularization term such as the norm of the generation function.

The learning module 112 updates the parameters of the generation function to optimize the value of the loss function (step S105). For example, the learning module 112 updates the parameters of the generation function so as to decrease the value of the loss function.

The learning module 112 determines whether to end the learning (step S106). While any method may be used to determine the end of learning, it is possible to apply a method that determines to end when the change in the value of the loss function becomes equal to or less than a threshold (threshold for the change in the value), for example.

When it is determined not to end the learning (No at step S106), the processing returns to step S103 and is repeated therefrom. The same input signals or different input signals may be used in the repetition.

When it is determined to end the learning (Yes at step S106), the learning module 112 outputs the learned generation function (step S107), and ends the learning processing.

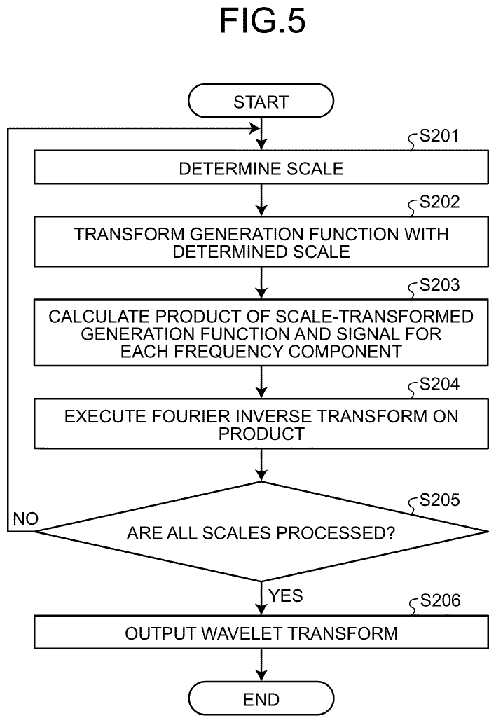

Next, the details of the calculation processing of the wavelet representation at step S103 will be described. FIG. 5 is a flowchart illustrating an example of the calculation processing of the wavelet representation.

The learning module 112 determines the scale (step S201). For example, the learning module 112 determines one of a plurality of scales a defined in advance.

The learning module 112 transforms the generation function with the determined scale a (step S202). For example, the learning module 112 transforms the generation function to have the input signal multiplied by the scale a as the input.

For each of the frequency components of the input signal, the learning module 112 calculates the product of the scale-transformed generation function and the frequency component of the input signal (step S203). The learning module 112 executes the Fourier inverse transform on the calculated product (step S204). Thereby, the continuous wavelet representation T^{wav}f is calculated as in the equation (6) using the determined scale a.

The learning module 112 determines whether all scales are processed (step S205). When all scales are not processed (No at step S205), the learning module 112 returns to step S201 to determine the next scale and repeats the processing.

When all scales are processed (Yes at step S205), the learning module 112 outputs the continuous wavelet transform calculated for all designated scales (step S206), and ends the calculation processing of the wavelet representations.

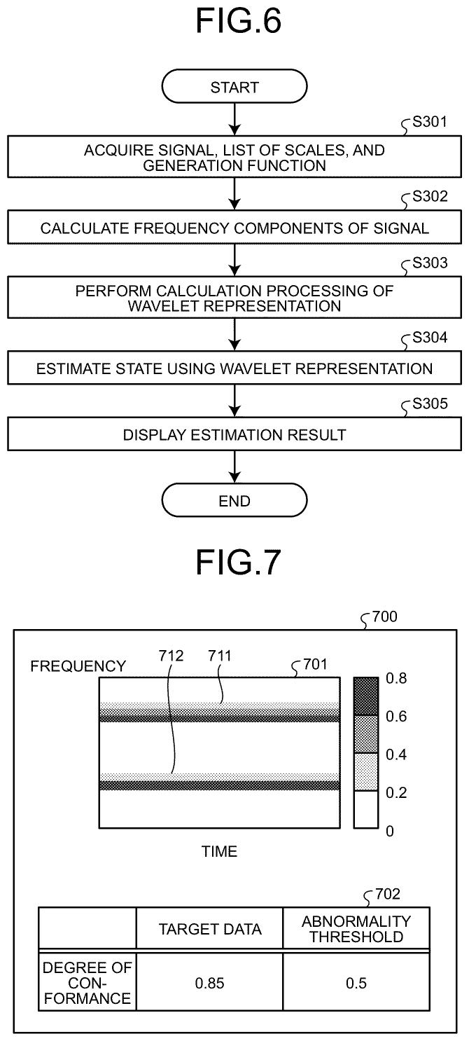

Next, estimation processing performed by the information processing device 100 according to the first embodiment will be described. FIG. 6 is a flowchart illustrating an example of the estimation processing according to the first embodiment.

The calculation module 121 acquires the input signal for estimation, a list of scales, and the generation function (step S301). The input signal is, for example, received at the reception module 101. The generation function is a generation function learned by the learning processing. The list of scales is information designating a plurality of scales to be used for estimation. The list of scales may be designated by the user or the like and received at the reception module 101. As described above, the calculation module 121 may determine the range and resolution of the scales based on the magnitude of the frequency components of the signal to be applied, and create a list of scales.

The calculation module 121 calculates the frequency components of the input signal (step S302). For example, the calculation module 121 calculates the frequency components of the input signal using the fast Fourier transform, the Blackman-Turkey method, the maximum entropy method, and the like.

The calculation module 121 calculates the continuous wavelet representation T^{wav}f using the calculated frequency components and the acquired generation function (step S303). The calculation module 121 can calculate the continuous wavelet representation T^{wav}f using the same procedure as in FIG. 5. Note that the learning module 112 and the calculation module 121 may be configured to share the function to execute the calculation processing of the wavelet representation.

The estimation module 122 estimates the state of the target using the output signal (continuous wavelet representation) calculated by the calculation module 121 (step S304). For example, the estimation module 122 compares the degree of conformance calculated from the continuous wavelet representation with the threshold to estimate the state of the target based on the comparison result.

The output control module 102 displays the estimation result acquired by the estimation module 122 on the display unit 152 (step S305), and ends the estimation processing.

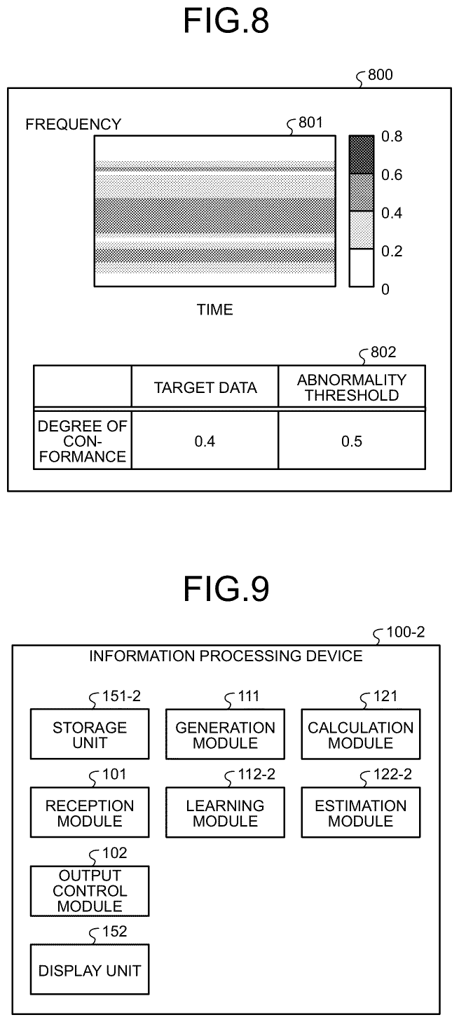

FIG. 7 and FIG. 8 are diagrams illustrating examples of the display screen of the estimation result displayed on the display unit 152. FIG. 7 is an example of a display screen 700 that includes the estimation result when determined to be normal. As illustrated in FIG. 7, the display screen 700 includes a wavelet representation 701 and a degree of conformance display column 702.

The wavelet representation 701 is expressed by two-dimensional coordinates with time and frequency on the horizontal and vertical axes, respectively. Note that the wavelet representation 701 is a real value (value from 0 through 0.8 in FIG. 7), such as a feature value calculated from the continuous wavelet representation T^{wav}f, for example.

When the state is normal, for example, it is to be noted that the input signal to be the target in the example of FIG. 7 includes a wavelet representation corresponding to a low frequency and a wavelet representation corresponding to a high frequency. Wavelet representations 711 and 712 in FIG. 7 correspond to such low frequency and high frequency wavelet representations. In other words, FIG. 7 indicates an example where a wavelet representation that better fits the wavelet representation when the state is normal.

Assuming that the threshold for state determination is 0.5, the estimation module 122 estimates that the state is normal since the degree of conformance of the input signal to be the target (target data) is 0.85 in the example in FIG. 7.

FIG. 8 is an example of a display screen 800 that includes the estimation result when determined to be anomalous. As illustrated in FIG. 8, the display screen 800 includes a wavelet representation 801 and a degree of conformance display column 802. In the example in FIG. 8, the wavelet representation 801 includes wavelet representations corresponding to various frequencies, unlike the wavelet representation 701 in FIG. 7. In other words, FIG. 8 indicates an example where a wavelet representation, which does not fit the wavelet representation of the case where the state is normal, is acquired.

Assuming that the threshold for state determination is 0.5, the estimation module 122 estimates that the state is anomalous since the degree of conformance of the input signal to be the target (target data) is 0.4 in the example in FIG. 8.

The output control module 102 may display only the degree of conformance display columns 702 (FIG. 7) and 802 (FIG. 8) corresponding to the estimation results, or it may display the wavelet representations 701 and 801 along therewith as in FIG. 7 and FIG. 8. Displaying the wavelet representation allows visualization of the basis for the estimation result.

The acquired wavelet representation may also be used as input for Artificial Intelligence (AI) models such as Support Vector Machines (SVM). Furthermore, the acquired wavelet representation may also be utilized in denoising processing and the like by restoring it to the original signal.

As described, the information processing device according to the first embodiment expresses a generation function for generating a local waveform used for the continuous wavelet transform by a machine learning model, and learns the generation function by unsupervised learning. Thus, it is possible to construct task-specific wavelets without using existing wavelets, for example. This makes it possible to execute analysis of signals using the wavelet transform with higher accuracy.

### Second Embodiment

An information processing device according to a second embodiment learns a generation function by supervised learning. Hereinafter, an example will be described, which learns a generation function that can be used for a classification task to determine which of a plurality of labels (classes) an input signal corresponds to. Applicable tasks thereof are not limited thereto, and it can be applied to a regression task, and the like, for example.

FIG. 9 is a block diagram illustrating an example of the configuration of an information processing device 100-2 according to the second embodiment. As illustrated in FIG. 9, the information processing device 100-2 includes a storage unit 151-2, a display unit 152, a reception module 101, an output control module 102, a generation module 111, a learning module 112-2, a calculation module 121, and an estimation module 122-2.

In the second embodiment, the functions of the storage unit 151-2, the learning module 112-2, and the estimation module 122-2 are different from the first embodiment. Other configurations and functions are the same as illustrated in FIG. 1 that is a block diagram of the information processing device 100 of the first embodiment, so the same reference signs are applied and the explanation herein are omitted.

The storage unit 151-2 differs from the storage unit 151 of the first embodiment in respect that it stores learning data including a label indicating the correct answer used for supervised learning. The learning data is, for example, data in which an input signal is mapped to a label into which the input signal is classified among a plurality of labels.

The learning module 112-2 learns a generation function by supervised learning using learning data that includes a label indicating the correct answer. The learning module 112-2 uses a functional for transforming from a continuous wavelet representation to a prediction value corresponding to a task. The learning module 112-2 prepares, for example, a functional Ψ that is expressed by the following equation (15).

$$Ψ [ {T}^{wav} f ] = \int dloga \int db \vert {T}^{wav} f ( a , b ) \vert ϕ ( loga , b ) \qquad ( 15 )$$

The functional Ψ of the equation (15) is a function that transforms from the continuous wavelet representation to a real number, and it contains a term corresponding to the inner product of the continuous wavelet representation and an aggregate function Φ. The aggregate function Φ is defined in advance as a function that aggregates the continuous wavelet representation into a value corresponding to one of a plurality of labels. A plurality of aggregate functions Φ are defined by corresponding to each of the labels to be classified. Note that the aggregate function Φ may be a function determined in advance, or it may be constructed as a machine learning model such as a neural network, which may be constructed in advance or simultaneously with the generation function by machine learning.

In a case of a classification task, the learning module 112-2 performs learning using softmax cross entropy expressed in the following equation (16), for example, as the loss function. Hereinafter, signals and labels contained in the learning data are denoted as fᵢ and yᵢ (i is an integer of 1 through N, both inclusive, where N is 2 or more), respectively.

$$- \frac{1}{N} {\sum }_{i}^{N} {y}_{i} \cdot log {p}_{i} \qquad ( 16 )$$

Assuming that there are L labels (L is an integer of 2 or greater) classified by the classification tasks, each of the functionals Ψᵢ, . . . , Ψ_{L} corresponds to one of the L labels. Furthermore, each of the labels is expressed by a one-hot vectorized vector yᵢ. Note that pᵢ in the equation (16) is expressed, for example, by the following equation (17). Also, softmax within the equation (17) is expressed, for example, by the following equation (18).

$$\begin{matrix}{p}_{i} = softmax ( {Ψ}_{1} [ {T}^{wav} {f}_{i} ) , … , {Ψ}_{L} [ {T}^{wav} {f}_{i} ] ) & ( 17 ) \\ {softmax ( {x}_{1} , … , {x}_{N} )}_{j} = {e}^{- {x}_{i}} / {\sum }_{i}^{n} {e}^{- {x}_{i}} & ( 18 )\end{matrix}$$

Note that the loss function that can be used in the classification task is not limited to the softmax cross entropy mentioned above, but may be any conventionally used loss function.

In a case of a regression task, the learning module 112-2 performs learning using the squared error

$$\frac{1}{N} {\sum }_{i}^{N} {\vert Ψ [ {T}^{wav} {f}_{i} ] - {y}_{i} \vert}^{2} \qquad ( 19 )$$

expressed in the following equation (19), for example, as the loss function.

The learning module 112-2 may learn both the generation function and the aggregate function collectively, or may learn one of those at a time using an unsupervised learning method as well.

The learning module 112-2 may execute supervised learning by contrastive learning. In the contrastive learning, learning is performed such that continuous wavelet representations of signals belonging to different labels are kept away from each other. In the contrastive learning, the contrastive loss E(fᵢ, fⱼ) expressed by the following equation (20) or the contrastive loss E(f, f⁺, f⁻) expressed in the equation (21), for example, is used as the loss function.

$$\begin{matrix}E ( {f}_{i} , {f}_{j} ) = \{ \begin{matrix}{‖ {T}^{wav} {f}_{i} - {T}^{wav} {f}_{j} ‖}_{2}^{2} , CASE WHERE LABELS OF {f}_{i} AND {f}_{j} ARE SAME \\ max ( 0 , m - {‖ {T}^{wav} {f}_{i} - {T}^{wav} {f}_{j} ‖}_{2}^{2} , OTHER THAN ABOVE CASE\end{matrix} & ( 20 ) \\ E ( f , {f}^{+} , {f}^{-} ) = max ( 0 , {‖ {T}^{wav} f - {T}^{wav} {f}^{+} ‖}_{2}^{2} - {‖ {T}^{wav} f - {T}^{wav} {f}^{-} ‖}_{2}^{2} + m ) & ( 21 )\end{matrix}$$

Note that m is a positive hyperparameter. In the equation (21), f represents the reference signal, f⁺ represents a signal belonging to the same class as f, and f⁻ represents a signal belonging to a class different from f.

The estimation module 122-2 differs from the estimation module 122 of the first embodiment in respect that it estimates the state using a functional including an aggregate function. For example, the estimation module 122-2 calculates the value of the functional corresponding to each label, including the aggregate function corresponding to each label, and uses the calculated values to calculate the probability (classification probability) of each label as an estimation result. The probability represents the degree of confidence that the input signal corresponds to each label, for example. The probability may be calculated such that the total sum of the probabilities for each of the labels becomes 1.

Since the overall flows of the learning processing (FIG. 4), the wavelet representation calculation processing (FIG. 5), and the estimation processing (FIG. 6) are the same as those of the first embodiment, explanations thereof are omitted. In the present embodiment, the specific processing for updating parameters using loss functions (step S105 in FIG. 4) and estimation using wavelet representation (step S304 in FIG. 6), for example, differs from the first embodiment.

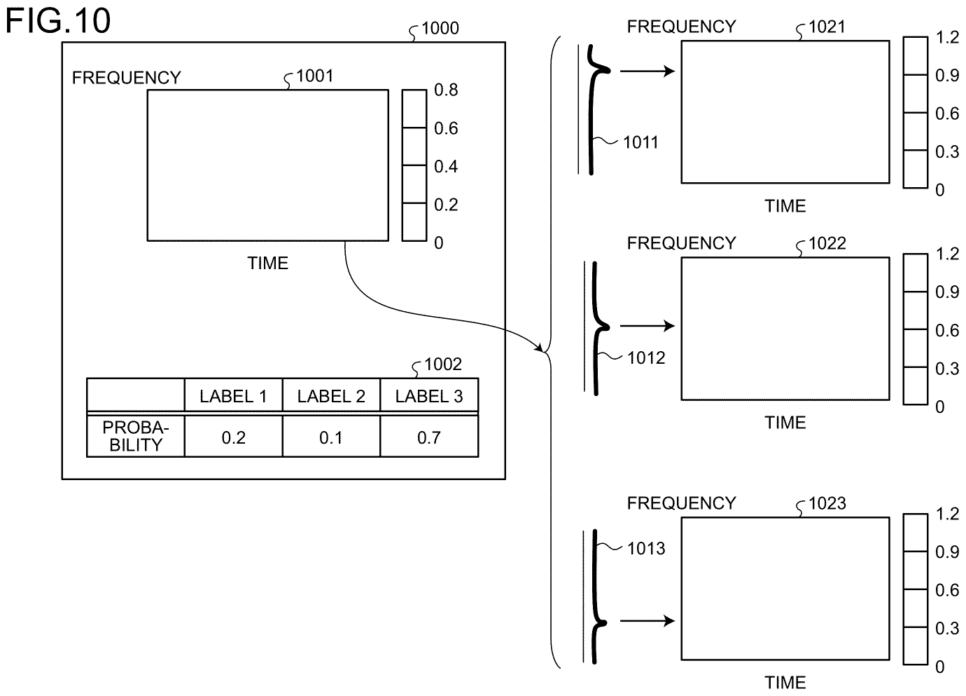

FIG. 10 is a diagram illustrating an example of a display screen 1000 according to the present embodiment. The display screen 1000 according to the present embodiment includes, for example, a wavelet representation 1001 and a probability display column 1002 that represents the estimation result. The wavelet representation 1001 may be displayed separately for each frequency corresponding to each label. In FIG. 10, three aggregate functions 1011 to 1013 corresponding to three labels 1 to 3, and three wavelet representations 1021 to 1023 are illustrated.

As described, the output control module 102 may further output information indicating the aggregate function. Displaying the aggregate function allows visualization of the basis for the estimation result.

When a label is designated on the display screen 1000, for example, the output control module 102 may display the aggregate function and the wavelet representation corresponding to the designated label. In the example of FIG. 10, when label 1 is designated on the display screen 1000, the output control module 102 may display the aggregate function 1011 and the wavelet representation 1021.

The information corresponding to the designated label may be displayed with the display screen 1000 or may be displayed as a screen separate from the display screen. The output control module 102 may display a display screen that includes the aggregate functions and wavelet representations for all labels.

Thus, as in the first embodiment, the information processing device according to the second embodiment can construct task-specific wavelets, even in a case of learning the generation function by supervised learning.

As described above, according to the first and second embodiments, it is possible to execute analysis of signals using the wavelet transform with higher precision.

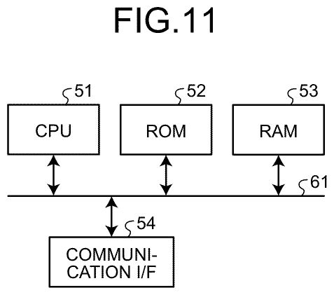

Next, the hardware configuration of the information processing device according to the first or second embodiment will be described by referring to FIG. 11. FIG. 11 is a diagram illustrating an example of the hardware configuration of the information processing device according to the first or second embodiment.

The information processing device according to the first or second embodiment includes a control device such as a CPU 51, memory devices such as a Read Only Memory (ROM) 52 and a RAM 53, a communication I/F 54 that is connected to a network for performing communication, and a bus 61 that connects each of the units.

The computer program to be executed by the information processing device according to the first or second embodiment is provided by being loaded in advance in the ROM 52 or the like.

The computer program to be executed by the information processing device according to the first or second embodiment may be recorded in an installable or executable format file on a computer readable recording medium such as a Compact Disk Read Only Memory (CD-ROM), a flexible disk (FD), a Compact Disk Recordable (CD-R), a Digital Versatile Disk (DVD), or the like, and may be provided as a computer program product.

Furthermore, the computer program to be executed by the information processing device according to the first or second embodiment may be stored on a computer connected to a network such as the Internet and may be provided by being downloaded via the network. The computer program executed by the information processing device according to the first or second embodiment may be provided or distributed via a network such as the Internet.

The computer program executed by the information processing device according to the first or second embodiment may cause the computer to function as each of the units of the information processing device described above. As for the computer, the CPU 51 can read the computer program from a computer-readable storage medium and execute it on the main memory.

Configuration examples of the embodiments are described below.

(Configuration example 1) An information processing device includes: one or more processors configured to: generate a generation function for generating a local waveform used for a continuous wavelet transform, at least part of the generation function being expressed by a machine learning model; and learn the generation function by using learning data including a first input signal.

(Configuration example 2) In the device according to Configuration example 1, the machine learning model includes a neural network model defined in a frequency domain.

(Configuration example 3) In the device according to Configuration example 1 or 2, the generation function outputs 0 when input is 0, and output of the generation function converges to 0 at a rate equal to or more than a threshold defined in advance as the input goes toward infinity.

(Configuration example 4) In the device according to any one of Configuration examples 1 to 3, the generation function outputs 0 when input is negative.

(Configuration example 5) In the device according to any one of Configuration examples 1 to 4, the one or more processors are configured to: perform Fourier inverse transform on a value acquired by multiplying, in a frequency domain, the first input signal by output of the generation function when the first input signal is input to calculate a first output signal that is acquired by performing continuous wavelet transform on the first input signal; and optimize a value of a loss function based on the first output signal to learn the generation function.

(Configuration example 6) In the device according to Configuration example 5, the one or more processors are configured to optimize the value of the loss function including an output value of a functional having the first output signal as input.

(Configuration example 7) In the device according to Configuration example 6, the one or more processors are configured to learn the generation function by unsupervised learning.

(Configuration example 8) In the device according to Configuration example 7, the functional outputs, as the output value, entropy of the first output signal.

(Configuration example 9) In the device according to Configuration example 7, the functional outputs, as the output value, a reconstruction error that indicates a difference between the first input signal and an input signal estimated from the first output signal.

(Configuration example 10) In the device according to Configuration example 6, the one or more processors are configured to learn the generation function by supervised learning using the learning data containing a label indicating a correct answer.

(Configuration example 11) In the device according to Configuration example 10, the supervised learning includes contrastive learning.

(Configuration example 12) In the device according to Configuration example 10, the functional includes an aggregate function that aggregates the first output signal to a value corresponding to the label.

(Configuration example 13) In the device according to Configuration example 5, the one or more processors are configured to: calculate a value of the first input signal in the frequency domain by fast Fourier transform; and perform Fourier inverse transform on the value acquired by multiplying, in the frequency domain, the first input signal by the output of the generation function when the first input signal is input.

(Configuration example 14) In the device according to Configuration example 13, the one or more processors are configured to execute the fast Fourier transform on the first input signal to which a window function including Hanning window, Hamming window, and Gaussian window is applied.

(Configuration example 15) In the device according to Configuration example 5, the one or more processors are configured to change the first output signal that is a value equal to or less than a threshold to 0.

(Configuration example 16) In the device according to any one of Configuration examples 1 to 15, the one or more processors are configured to: input a second input signal for estimating a state of a target to the learned generation function and calculate a second output signal acquired by performing continuous wavelet transform on the second input signal; and estimate the state by using the second output signal.

(Configuration example 17) In the device according to Configuration example 16, the second input signal is different from the first input signal at least in size or sampling rate.

(Configuration example 18) In the device according to Configuration example 16, the one or more processors are configured to determine a scale used in the continuous wavelet transform based on a frequency component of the second input signal.

(Configuration example 19) In the device according to Configuration example 16, the one or more processors are configured to change the second output signal that is a value equal to or less than a threshold to 0.

(Configuration example 20) In the device according to Configuration example 16, the one or more processors are configured to output a result of estimation.

(Configuration example 21) In the device according to Configuration example 20, the one or more processors are configured to: estimate the state by using a functional including an aggregate function that aggregates the second output signal to a value corresponding to the state; and further output information indicating the aggregate function.

(Configuration example 22) In the device according to Configuration example 21, the aggregate function is constructed by machine learning.

(Configuration example 23) In the device according to any one of Configuration examples 1 to 22, the one or more processors includes: a processor that generates the generation function; and a processor that learns the generation function.

(Configuration example 24) An information processing method, executed by an information processing device, includes: generating a generation function for generating a local waveform used for a continuous wavelet transform, at least part of the generation function being expressed by a machine learning model; and learning the generation function by using learning data including a first input signal.

(Configuration example 25) A computer program product includes a computer-readable medium including programmed instructions, which cause a computer to execute: generating a generation function for generating a local waveform used for a continuous wavelet transform, at least part of the generation function being expressed by a machine learning model; and learning the generation function by using learning data including a first input signal.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
one or more processors configured to:
generate a generation function for generating a local waveform used for a continuous wavelet transform, at least part of the generation function being expressed by a machine learning model; and
learn the generation function by using learning data including a first input signal.

2. The device according to claim 1, wherein the machine learning model includes a neural network model defined in a frequency domain.

3. The device according to claim 1, wherein the generation function outputs 0 when input is 0, and output of the generation function converges to 0 at a rate equal to or more than a threshold defined in advance as the input goes toward infinity.

4. The device according to claim 1, wherein the generation function outputs 0 when input is negative.

5. The device according to claim 1, wherein the one or more processors are configured to:
perform Fourier inverse transform on a value acquired by multiplying, in a frequency domain, the first input signal by output of the generation function when the first input signal is input to calculate a first output signal that is acquired by performing continuous wavelet transform on the first input signal; and
optimize a value of a loss function based on the first output signal to learn the generation function.

6. The device according to claim 5, wherein the one or more processors are configured to optimize the value of the loss function including an output value of a functional having the first output signal as input.

7. The device according to claim 6, wherein the one or more processors are configured to learn the generation function by unsupervised learning.

8. The device according to claim 7, wherein the functional outputs, as the output value, entropy of the first output signal.

9. The device according to claim 7, wherein the functional outputs, as the output value, a reconstruction error that indicates a difference between the first input signal and an input signal estimated from the first output signal.

10. The device according to claim 6, wherein the one or more processors are configured to learn the generation function by supervised learning using the learning data containing a label indicating a correct answer.

11. The device according to claim 10, wherein the supervised learning includes contrastive learning.

12. The device according to claim 10, wherein the functional includes an aggregate function that aggregates the first output signal to a value corresponding to the label.

13. The device according to claim 5, wherein the one or more processors are configured to:
calculate a value of the first input signal in the frequency domain by fast Fourier transform; and
perform Fourier inverse transform on the value acquired by multiplying, in the frequency domain, the first input signal by the output of the generation function when the first input signal is input.

14. The device according to claim 13, wherein the one or more processors are configured to execute the fast Fourier transform on the first input signal to which a window function including Hanning window, Hamming window, and Gaussian window is applied.

15. The device according to claim 5, wherein the one or more processors are configured to change the first output signal that is a value equal to or less than a threshold to 0.

16. The device according to claim 1, wherein the one or more processors are configured to:
input a second input signal for estimating a state of a target to the learned generation function and calculate a second output signal acquired by performing continuous wavelet transform on the second input signal; and
estimate the state by using the second output signal.

17. The device according to claim 16, wherein the second input signal is different from the first input signal at least in size or sampling rate.

18. The device according to claim 16, wherein the one or more processors are configured to determine a scale used in the continuous wavelet transform based on a frequency component of the second input signal.

19. The device according to claim 16, wherein the one or more processors are configured to change the second output signal that is a value equal to or less than a threshold to 0.

20. The device according to claim 16, wherein the one or more processors are configured to output a result of estimation.

21. The device according to claim 20, wherein the one or more processors are configured to:
estimate the state by using a functional including an aggregate function that aggregates the second output signal to a value corresponding to the state; and
further output information indicating the aggregate function.

22. The device according to claim 21, wherein the aggregate function is constructed by machine learning.

23. The device according to claim 1, wherein the one or more processors comprises:
a processor that generates the generation function; and
a processor that learns the generation function.

24. An information processing method executed by an information processing device, the method comprising:
generating a generation function for generating a local waveform used for a continuous wavelet transform, at least part of the generation function being expressed by a machine learning model; and
learning the generation function by using learning data including a first input signal.

25. A computer program product comprising a non-transitory computer-readable medium including programmed instructions, the instructions causing a computer to execute:
generating a generation function for generating a local waveform used for a continuous wavelet transform, at least part of the generation function being expressed by a machine learning model; and
learning the generation function by using learning data including a first input signal.
